(19) United States
(12) Patent Application Publication
(10) Pub. No.: US 2015/0241926 A1
(43) Pub. Date: Aug. 27, 2015

(54) MOBILE TERMINAL AND METHOD FOR CONTROLLING THE SAME

(71) Applicant: LG ELECTRONICS INC., Seoul (KR)

(72) Inventors: Daemyeong PARK, Seoul (KR); Soyoung BAE, Seoul (KR); Woong JEONG, Seoul (KR); Hongseok CHOI, Seoul (KR); Eun KWON, Seoul (KR)

(73) Assignee: LG ELECTRONICS INC., Seoul (KR)

(21) Appl. No.: 14/629,323

(22) Filed: Feb. 23, 2015

(30) Foreign Application Priority Data
Feb. 27, 2014 (KR) 10-2014-0023454

(51) Int. Cl. G06F 1/16; G06F 3/0488; G06F 3/0481; G06F 3/041; G06F 3/0482

(52) U.S. Cl. CPC G06F 1/1652; G06F 3/041; G06F 3/0482; G06F 3/04817; G06F 3/0488; G06F 2200/1636; G06F 2200/1637; G06F 2203/04102

(57) ABSTRACT

The present invention discloses a mobile terminal capable of controlling a main display area via an auxiliary display area implemented by a flexible display. In particular, according to the present invention, the mobile terminal includes a sensing unit configured to detect a movement of the mobile terminal, a display unit configured to contain a main display area exposed to the front side and an auxiliary display area exposed to the side and a controller, if the detected movement satisfies a prescribed condition, configured to control the display unit to switch to an image sharing mode, the controller, if the mobile terminal enters the image sharing mode, configured to control the display unit to output image data on the main display area and output a thumbnail list for a plurality of images on the auxiliary display area.

Pursuant to 35 U.S.C. §119(a), this application claims the benefit of earlier filing date and right of priority to Korean Application No. 10-2014-0023454, filed on Feb. 27, 2014, the contents of which are hereby incorporated by reference herein in their entirety.

### BACKGROUND OF THE INVENTION

1. Field of the Invention

The present invention relates to a mobile terminal enabling a user to more conveniently use the terminal and a method of controlling therefor.

2. Discussion of the Related Art

A mobile terminal is a device which may be configured to perform various functions. Examples of such functions include data and voice communications, capturing images and video via a camera, recording audio, playing music files and outputting music via a speaker system, and displaying images and video on a display. Some terminals include additional functionality which supports game playing, while other terminals are also configured as multimedia players. More recently, mobile terminals have been configured to receive broadcast and multicast signals which permit viewing of contents, such as videos and television programs.

Generally, terminals can be classified into mobile terminals and stationary terminals according to a presence or non-presence of mobility. And, the mobile terminals can be further classified into handheld terminals and vehicle mount terminals according to availability for hand-carry.

There are ongoing efforts to support and increase the functionality of mobile terminals. Such efforts include software and hardware improvements, as well as changes and improvements in the structural components which form the mobile terminal.

In general, a mobile terminal has a shape of a hexahedron. Yet, due to a recently developed flexible display, a method of diversifying the shape of the mobile terminal is found out. As an example, if the flexible display is applied, a mobile terminal of a cylinder form can be developed instead of the mobile terminal of the conventional hexahedron shape.

Putting aside the conventional hexahedron shape of the mobile terminal with the help of the development of the flexible display may mean that it is not necessary for a display to be exposed to the front side of the mobile terminal. Hence, development necessity of a new UI (user interface) applicable to the mobile terminal to which the flexible display is applied is increasing.

### SUMMARY OF THE INVENTION

Accordingly, one object of the present invention is to substantially obviate one or more problems due to limitations and disadvantages of the related art. Another object of the present invention is to provide a mobile terminal capable of providing an appropriate UI to the mobile terminal to which a flexible display is applied and a method of controlling therefor.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, according to one embodiment, a mobile terminal includes a sensing unit configured to detect a movement of the mobile terminal, a display unit configured to contain a main display area exposed to the front side and an auxiliary display area exposed to the side and a controller, if the detected movement satisfies a prescribed condition, configured to control the display unit to switch to an image sharing mode, the controller, if the mobile terminal enters the image sharing mode, configured to control the display unit to output image data on the main display area and output a thumbnail list for a plurality of images on the auxiliary display area.

In this case, the display unit includes a flexible display and the main display area and the auxiliary display area can be distinguished from each other by bending at least one or more ends of the flexible display.

And, the thumbnail list can be outputted on the basis of a direction different from an output direction of an image outputted on the main display area. And, the prescribed condition may correspond to a condition that a direction of a width of the display unit is vertical to the ground.

And, the prescribed condition may correspond to a condition that an operation of the mobile terminal rotating more than a prescribed angle is detected.

Or, the prescribed condition may correspond to a condition that a touch input of a user is received via the auxiliary display area.

And, the auxiliary display area includes a first auxiliary display area installed in a first side of the mobile terminal and a second auxiliary display area installed in a second side of the mobile terminal and the prescribed condition can include at least one or more first touch inputs inputted on the first auxiliary display area and at least two or more second touch inputs inputted on the second auxiliary display area.

And, if an input selecting an item from the outputted thumbnail list is received in the sharing mode, an image data corresponding to the selected item can be outputted on the main display area.

And, if the image data outputted on the main display area corresponds to a video data, a control area can be outputted on the auxiliary display area to control playback of the video data in the sharing mode.

And, if a playback command is received via the control area, the video data is played via the main display area and if the video data is played, a playback progressive bar can be outputted on the auxiliary display area in response to the playback.

To further achieve these objects and other advantages and in accordance with the purpose of the invention, as embodied and broadly described herein, according to a different embodiment, a method of controlling a mobile terminal, which is equipped with a display unit including a main display area exposed to the front side and an auxiliary display area exposed to the side, includes the steps of detecting a movement of the mobile terminal, if the detected movement satisfies a prescribed condition, switching to an image sharing mode and if the mobile terminal enters the image sharing mode, controlling the display unit to output image data on the main display area and output a thumbnail list for a plurality of images on the auxiliary display area. In this case, the display unit can include a flexible display and the main display area and the auxiliary display area can be distinguished from each other by bending at least one or more ends of the flexible display.

In this case, the thumbnail list can be outputted on the basis of a direction different from an output direction of an image outputted on the main display area.

And, the prescribed condition may correspond to a condition that a direction of a width of the display unit is vertical to the ground.

Or, the prescribed condition may correspond to a condition that an operation of the mobile terminal rotating more than a prescribed angle is detected.

And, the method can further include the step of detecting a touch input of a user via the display unit and the prescribed condition may correspond to a condition that the touch input of the user is received via the auxiliary display area.

And, the auxiliary display area includes a first auxiliary display area installed in a first side of the mobile terminal and a second auxiliary display area installed in a second side of the mobile terminal and the prescribed condition can include at least one or more first touch inputs inputted on the first auxiliary display area and at least two or more second touch inputs inputted on the second auxiliary display area.

And, if an input selecting an item from the outputted thumbnail list is received in the sharing mode, the method can further include the step of outputting an image data corresponding to the selected item on the main display area.

And, if the image data outputted on the main display area corresponds to a video data, the method can further include the step of outputting a control area on the auxiliary display area to control playback of the video data in the sharing mode.

And, if a playback command is received via the control area, the method can further include the step of playing the video data via the main display area and if the video data is played, the method can further include the step of outputting a playback progressive bar on the auxiliary display area in response to the playback.

It is to be understood that both the foregoing general description and the following detailed description of the preferred embodiments of the present invention are exemplary and explanatory and are intended to provide further explanation of the invention as claimed.

### BRIEF DESCRIPTION OF THE DRAWINGS

The above and other aspects, features, and advantages of the present invention will become more apparent upon consideration of the following description of preferred embodiments, taken in conjunction with the accompanying drawing figures.

FIG. 1A is a block diagram of a mobile terminal in accordance with the present disclosure;

FIGS. 1B and 1C are conceptual views of one example of the mobile terminal, viewed from different directions;

FIG. 2 is a conceptual view of a deformable mobile terminal according to an alternative embodiment of the present disclosure;

FIGS. 3A and 3B are diagrams for an example of a mobile terminal 100 including a main display area and an auxiliary display area;

FIG. 4 is a diagram for an example of a situation to which one embodiment of the present invention is applied;

FIG. 5 is a flowchart for a control method outputting data information on an auxiliary display area according to one embodiment of the present invention;

FIG. 6 is a diagram for a first example of a gesture to enter a sharing mode according to one embodiment of the present invention;

FIGS. 7A and 7B are diagrams for a second example of a gesture to enter a sharing mode according to one embodiment of the present invention;

FIGS. 8A and 8B are diagrams for a control method displaying an image and a thumbnail list in a sharing mode according to one embodiment of the present invention;

FIGS. 9A and 9B are diagrams for a control method of a criterion differently outputting a main display area 151-1 and an auxiliary area 151-2;

FIGS. 10A and 10B are diagrams for a control method controlling a main display area 151-1 using a thumbnail list according to one embodiment of the present invention;

FIGS. 11A and 11B are diagrams for a control method outputting a control area configured to control playback of a video data on an auxiliary display area 151-2 according to one embodiment of the present invention;

FIGS. 12A and 12B are diagrams for a control method outputting a playback progressive bar on an auxiliary display area 151-2 while a video data is played according to one embodiment of the present invention;

FIGS. 13A and 13B are diagrams for a control method controlling an output of a main display area in response to a touch gesture input of a user received on an auxiliary display area according to one embodiment of the present invention;

FIGS. 14A and 14B are diagrams for a control method outputting a control area necessary for playing music via an auxiliary display area according to one embodiment of the present invention in case of executing a music playback application;

FIGS. 15A and 15B are diagrams for explaining a merit of a control method controlling music playback in an auxiliary display area according to one embodiment of the present invention.

### DETAILED DESCRIPTION OF THE INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

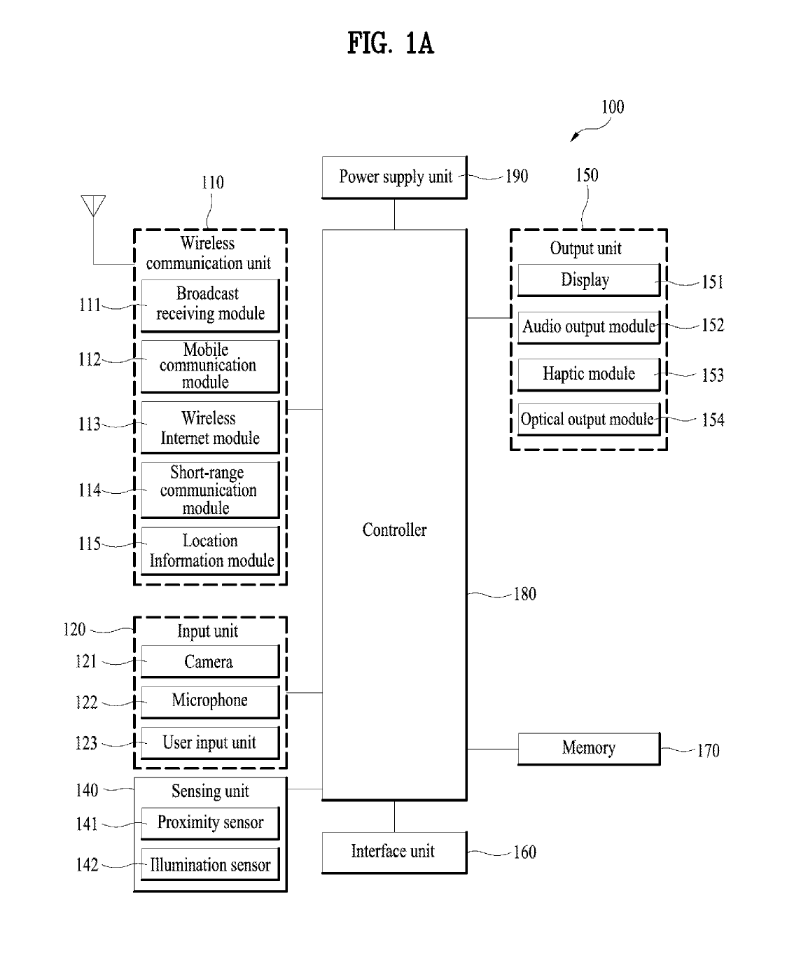

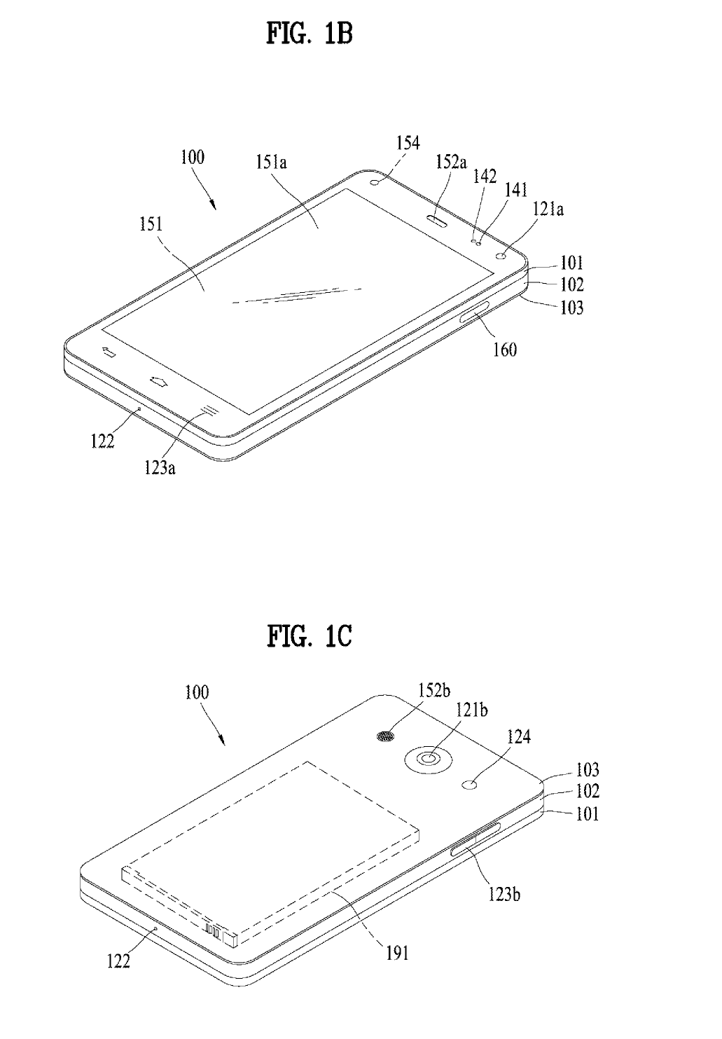

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring now to FIG. 1A, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154.

The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components depicted in FIG. 1A, or activating application programs stored in the memory 170. As one example, the controller 180 controls some or all of the components illustrated in FIGS. 1A-1C according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Referring still to FIG. 1A, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000(Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like). Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

FIGS. 1B and 1C depict certain components as arranged on the mobile terminal. However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject.

As shown in FIG. 1B, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

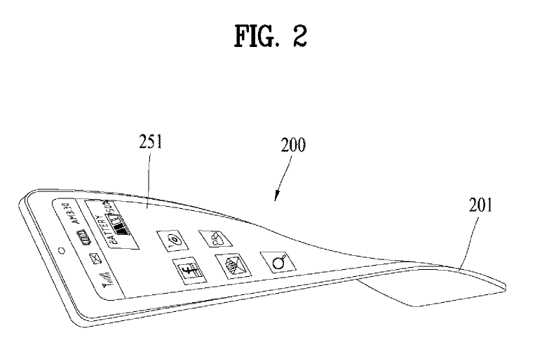

FIG. 2 is a conceptual view of a deformable mobile terminal according to an alternative embodiment of the present invention. In this figure, mobile terminal 200 is shown having display unit 251, which is a type of display that is deformable by an external force. This deformation, which includes display unit 251 and other components of mobile terminal 200, may include any of curving, bending, folding, twisting, rolling, and combinations thereof. The deformable display unit 251 may also be referred to as a “flexible display unit.” In some implementations, the flexible display unit 251 may include a general flexible display, electronic paper (also known as e-paper), and combinations thereof. In general, mobile terminal 200 may be configured to include features that are the same or similar to that of mobile terminal 100 of FIGS. 1A-1C.

The flexible display of mobile terminal 200 is generally formed as a lightweight, non-fragile display, which still exhibits characteristics of a conventional flat panel display, but is instead fabricated on a flexible substrate which can be deformed as noted previously.

The term e-paper may be used to refer to a display technology employing the characteristic of a general ink, and is different from the conventional flat panel display in view of using reflected light. E-paper is generally understood as changing displayed information using a twist ball or via electrophoresis using a capsule.

When in a state that the flexible display unit 251 is not deformed (for example, in a state with an infinite radius of curvature and referred to as a first state), a display region of the flexible display unit 251 includes a generally flat surface. When in a state that the flexible display unit 251 is deformed from the first state by an external force (for example, a state with a finite radius of curvature and referred to as a second state), the display region may become a curved surface or a bent surface. As illustrated, information displayed in the second state may be visual information output on the curved surface. The visual information may be realized in such a manner that a light emission of each unit pixel (sub-pixel) arranged in a matrix configuration is controlled independently. The unit pixel denotes an elementary unit for representing one color.

According to one alternative embodiment, the first state of the flexible display unit 251 may be a curved state (for example, a state of being curved from up to down or from right to left), instead of being in flat state. In this embodiment, when an external force is applied to the flexible display unit 251, the flexible display unit 251 may transition to the second state such that the flexible display unit is deformed into the flat state (or a less curved state) or into a more curved state.

If desired, the flexible display unit 251 may implement a flexible touch screen using a touch sensor in combination with the display. When a touch is received at the flexible touch screen, the controller 180 can execute certain control corresponding to the touch input. In general, the flexible touch screen is configured to sense touch and other input while in both the first and second states.

One option is to configure the mobile terminal 200 to include a deformation sensor which senses the deforming of the flexible display unit 251. The deformation sensor may be included in the sensing unit 140.

The deformation sensor may be located in the flexible display unit 251 or the case 201 to sense information related to the deforming of the flexible display unit 251. Examples of such information related to the deforming of the flexible display unit 251 may be a deformed direction, a deformed degree, a deformed position, a deformed amount of time, an acceleration that the deformed flexible display unit 251 is restored, and the like. Other possibilities include most any type of information which can be sensed in response to the curving of the flexible display unit or sensed while the flexible display unit 251 is transitioning into, or existing in, the first and second states.

In some embodiments, controller 180 or other component can change information displayed on the flexible display unit 251, or generate a control signal for controlling a function of the mobile terminal 200, based on the information related to the deforming of the flexible display unit 251. Such information is typically sensed by the deformation sensor.

The mobile terminal 200 is shown having a case 201 for accommodating the flexible display unit 251. The case 201 can be deformable together with the flexible display unit 251, taking into account the characteristics of the flexible display unit 251.

A battery (not shown in this figure) located in the mobile terminal 200 may also be deformable in cooperation with the flexible display unit 261, taking into account the characteristic of the flexible display unit 251. One technique to implement such a battery is to use a stack and folding method of stacking battery cells.

The deformation of the flexible display unit 251 not limited to perform by an external force. For example, the flexible display unit 251 can be deformed into the second state from the first state by a user command, application command, or the like.

A display unit 151 of a mobile terminal 100 according to the present invention can include a main display area exposed to the front side of the mobile terminal 100 and at least one or more auxiliary display areas exposed to the side of the mobile terminal 100.

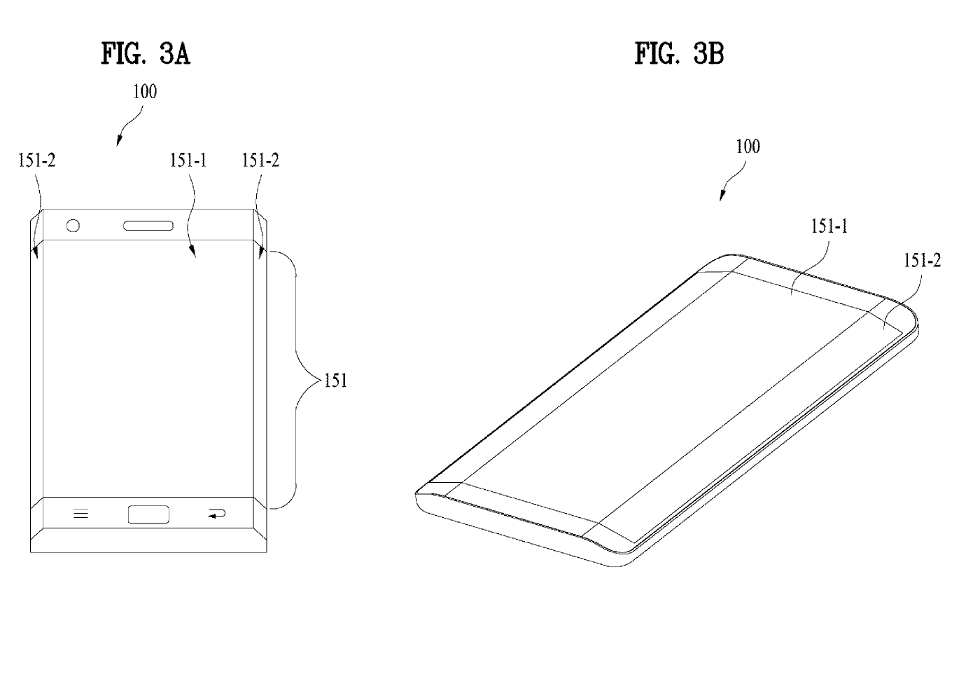

FIGS. 3A and 3B are diagrams for an example of a mobile terminal 100 including a main display area and an auxiliary display area. As shown in an example of FIG. 3A, a main display area 151-1 corresponds to a display area exposed to the front side of the mobile terminal 100 and an auxiliary display area 151-2 may correspond to a display area exposed to the side of the mobile terminal 100. FIG. 3B is a perspective diagram of the mobile terminal 100.

Each of the main display area 151-1 and the auxiliary display area 151-2 can be implemented by a separate electronic component. On the contrary, if the display unit 151 is implemented by a flexible display capable of being freely bent, the main display area 151-1 and the auxiliary display area 151-2 can be formed in a manner of bending at least one or more ends of the flexible display.

Meanwhile, according to the example shown in FIG. 3, the auxiliary display area 151-2 is installed in both a left end and a right end of the mobile terminal 100. Yet, the auxiliary display area can be installed in one end only among the left and the right end.

Embodiments of the present invention intend to propose a control method capable of easily showing a picture to a different person using a mobile terminal 100 in which the aforementioned flexible display is installed.

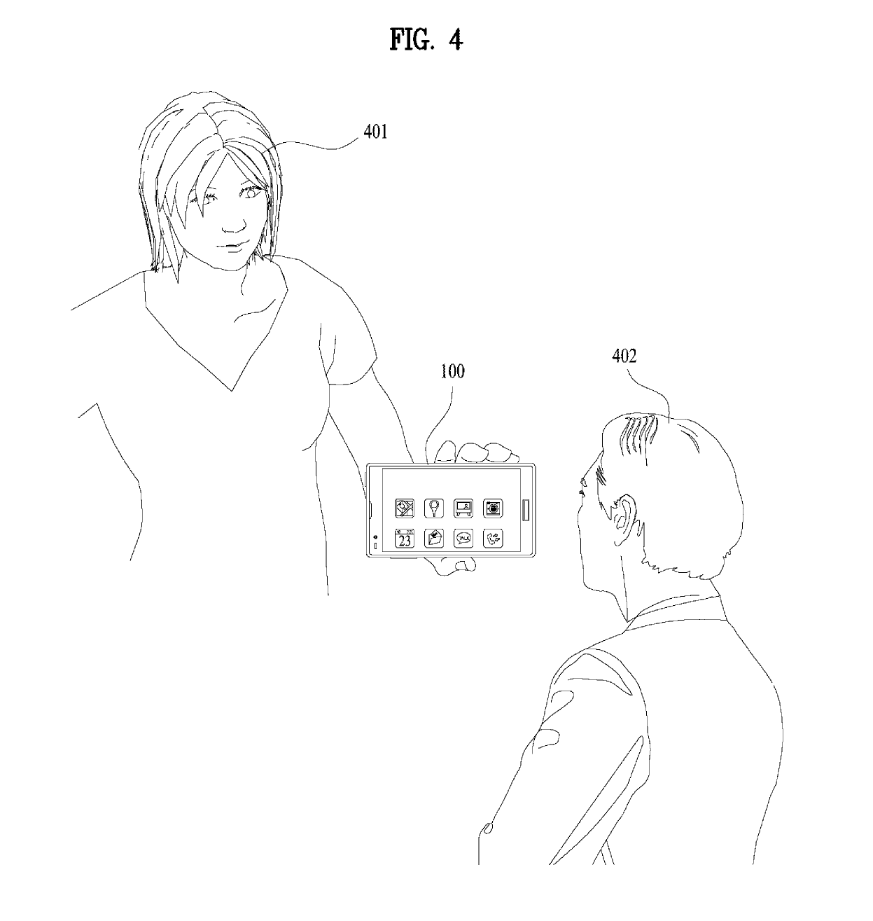

FIG. 4 is a diagram for an example of a situation to which one embodiment of the present invention is applied.

A user of a mobile terminal 100 may want to show a data outputted via a display 151 to a different person 402 (hereinafter a counterpart). For instance, the user of the mobile terminal may show a picture taken by the user to a different person or intend to make a presentation to a different person by outputting data via the display 151.

When a user 401 of the mobile terminal 100 and a counterpart 402 are facing each other, if an output direction of the display 151 faces the counterpart 402, the user 401 is able to check no information on an output screen currently displayed on the display 151 and is unable to perform any operation for the outputted screen.

Hence, embodiments of the present invention propose to output information for the user 401 using an auxiliary display area 151-2. In particular, when the main display area 151-1 faces the counterpart 402, the user 401 can check outputted information using the auxiliary display area 151-2.

Since the auxiliary display area 151-2 corresponds to an area outputting data at the side of the mobile terminal 100 using a flexible display, although the main display area 151-1 faces the counterpart 402, the user 401 can read the data via the auxiliary display area.

In the following drawing, although the main display area 151-1 and the auxiliary display area 151-2 are depicted as being outputted on a same flat, it is apparent that the auxiliary display area 151-2 can be outputted on the side of the mobile terminal 100.

And, information outputted on the auxiliary display area 151-2 may include a preview screen, a title, brief summary information and the like of the data outputted toward the counterpart 402.

Moreover, one embodiment of the present invention proposes to control the data outputted on the main display area 151-1 using the auxiliary display area 151-2.

In the following, a concrete control method is explained with reference to attached drawings.

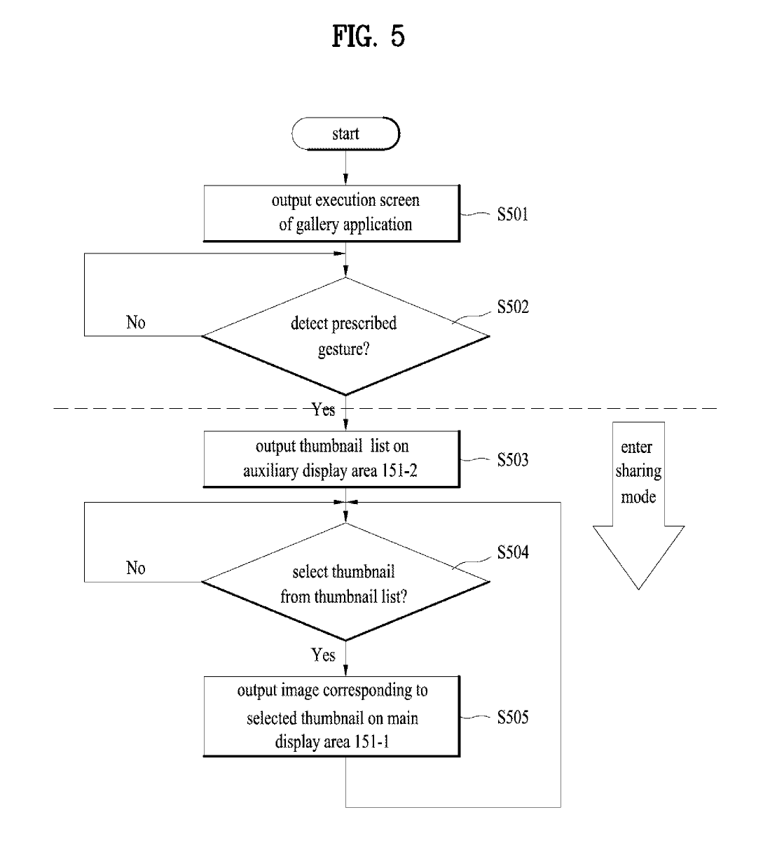

FIG. 5 is a flowchart for a control method outputting data information on an auxiliary display area according to one embodiment of the present invention.

The flowchart shown in FIG. 5 explains an example of using a gallery application, by which the present invention may be non-limited.

In the step S501, a controller 180 outputs an execution screen of a gallery application. In one embodiment of the present invention, a mode configured to show an output data to a different person is called a sharing mode. In the step S502, the controller 180 determines whether a prescribed gesture is detected via a mobile terminal 100. If the prescribed gesture is detected, the controller 180 enters the sharing mode.

The prescribed gesture corresponds to a user command to enter the sharing mode. The prescribed gesture can be detected using a sensing unit 140 of the mobile terminal 100 configured to detect a movement. In particular, the present invention proposes to automatically switch to the sharing mode when a movement is detected by the sensing unit 140 of the mobile terminal 100. Examples of the prescribed gesture are explained more in the following description.

Gesture for Automatically Entering Sharing Mode

A controller can control to automatically enter a sharing mode without a separate operation from a user when the user intends to show a picture to a counterpart 402 while an image data is outputted using a gallery application. In particular, the controller 180 can control to enter the sharing mode by detecting a prescribed gesture inputted on a sensing unit 140 or a touch screen 151. The prescribed gesture used for entering the sharing mode should be a gesture capable of correctly detecting an execution intention of a user. Hence, embodiments of the present invention propose to enter the sharing mode using gestures described in the following. One of a plurality of gestures disclosed in the following can be independently applied. And, a part of a plurality of the gestures can also be applied in a manner of being combined with each other.

### (1) First Example of Gesture

### Flipping Gesture

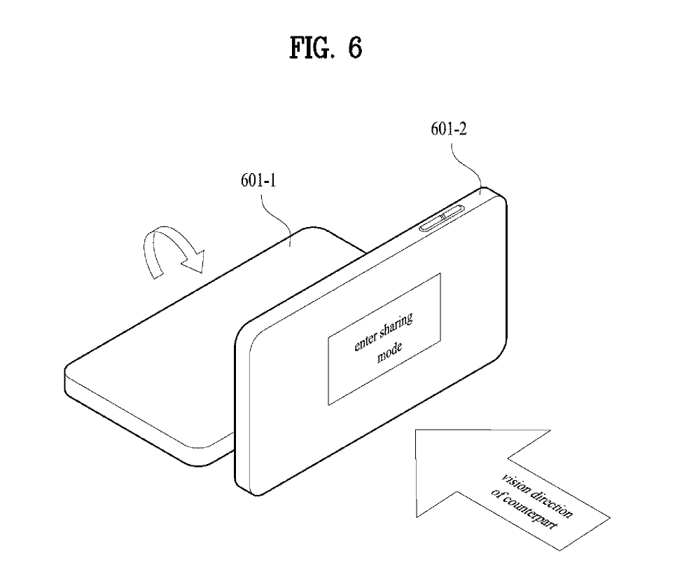

FIG. 6 is a diagram for a first example of a gesture to enter a sharing mode according to one embodiment of the present invention.

As a first example, when a surface of a display 151 is heading to the sky 601-1, if the surface of the display 151 rotates in a gaze direction of a counterpart 402 and the rotation is detected (rotates to a state of 601-2), the controller 180 may determine it as a gesture to enter the sharing mode. In particular, the controller detects a gesture of flipping a surface of the mobile terminal 100 in the gaze direction of the counterpart 402.

More specifically, from a state that the surface of the display 151 is heading to the sky, if the controller 180 detects that the mobile terminal 100 rotates to make the surface of the display 151 perpendicular to the ground, the controller can control to enter the sharing mode.

Moreover, the controller 180 can enter the sharing mode by further detecting whether the mobile terminal 100 is in a landscape mode as well as the rotation. In particular, if an operation mode of the mobile terminal 100 becomes the landscape mode by the rotation, the controller 180 can enter the sharing mode. The landscape mode corresponds to a case that a direction of a length of the display 151 is horizontal to the ground or a case that a direction of a width of the display 151 is vertical to the ground.

In the following, a control method capable of being implemented by the aforementioned mobile terminal and related embodiments are explained with reference to attached drawings. It will be apparent to those skilled in the art that the present invention can be specified into other form(s) without departing from the spirit or scope of the inventions.

### (2) Second Example of Gesture

### Touch Input Inputted on Touch Screen 151

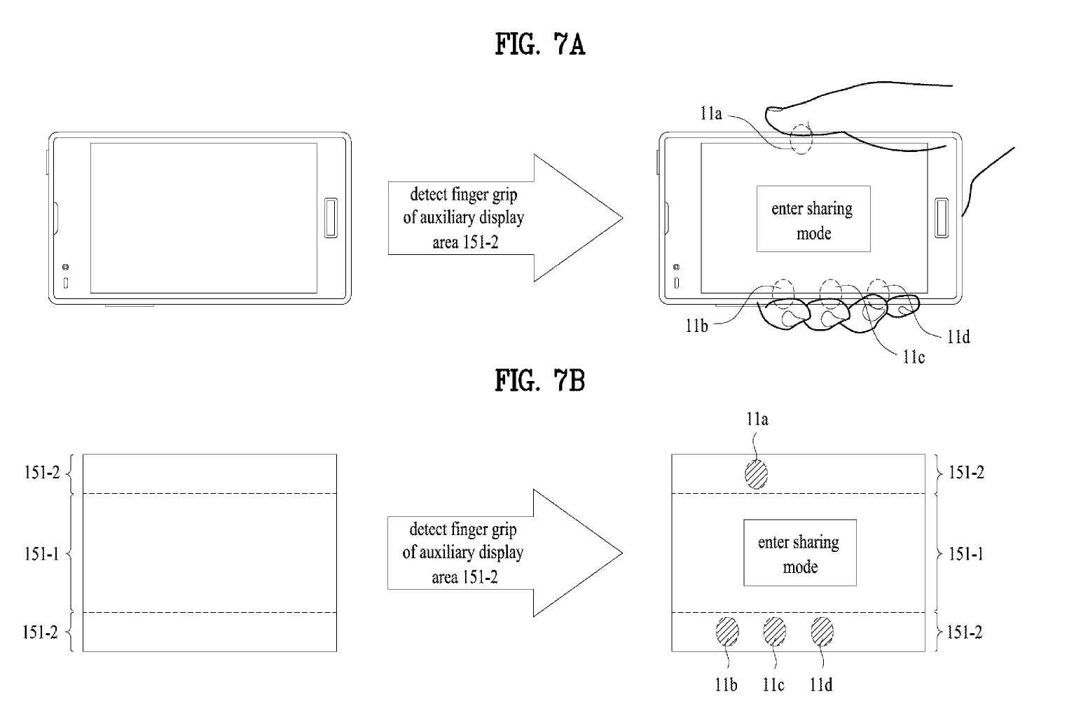

FIGS. 7A and 7B are diagrams for a second example of a gesture to enter a sharing mode according to one embodiment of the present invention. The second example proposes to enter the sharing mode based on a touch input detected by a touch screen 151.

In order to make a surface of a display 151 face a counterpart 402, a side of a mobile terminal 100 is gripped like as shown in FIG. 7A. In the second example, it may enter a sharing mode by recognizing the grip and using a recognized result.

FIG. 7B is a diagram for more clearly showing a touch input detected by a main display area 151-1 and an auxiliary display area 151-2. As shown in FIG. 7A, a plurality of touch inputs 11a to 11d can be detected by a touch screen according to a grip of a user.

In case that a touch input of a user is detected by the auxiliary display area 151-2, the grip shown in FIG. 7 may detect a touch input of a user inputted via the auxiliary display area 151-2. As shown in FIG. 7B, a plurality of touch inputs 11a to 11d can be detected on the auxiliary display 151-2 according to a grip of a user.

As an example, if a touch is inputted on the top of the auxiliary display area 151-2 and two or more touches are inputted on the bottom of the auxiliary display area 151-2, the controller 180 can enter the sharing mode.

### (3) Third Example of Gesture

### Directional Microphone 122

In case of using a plurality of microphones 122, it may determine an original location of a received voice using time difference of voice data received from each of a plurality of the microphones. In the third example, it is proposed to enter a sharing mode by determining an original location of a user 401.

When a user 401 of the mobile terminal 100 and a counterpart 402 are facing each other, if a surface of a display 151 faces the counterpart 402, the user 401 may face opposite side of the display 151. Hence, if it is determined that a direction of an original location of a voice exists at a direction opposite to the surface of the display 151 via a directional microphone 122, the controller 180 may enter the sharing mode. Moreover, the controller 180 identifies a voice of a user and may apply an original location of the identified user voice as a sharing mode entering condition only.

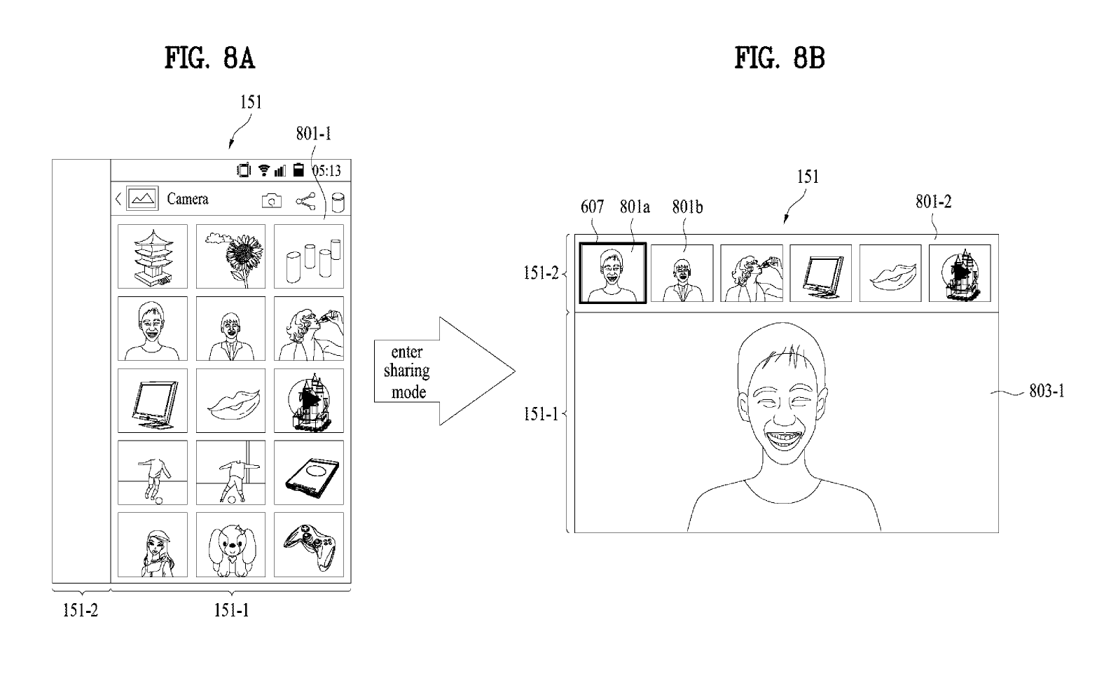

Referring back to FIG. 5, the controller 180 outputs a thumbnail list on an auxiliary display area 151-2 in the sharing mode [S503]. In this case, the thumbnail list can include a preview thumbnail for a plurality of images data as well as a title for a specific data or brief summary information as an item. Regarding an operation for entering the sharing mode, it shall be explained in more detail with reference to FIGS. 8A and 8B.

Control of Auxiliary Display Area in Sharing Mode

FIGS. 8A and 8B are diagrams for a control method displaying an image and a thumbnail list in a sharing mode according to one embodiment of the present invention. FIG. 8 is explained with reference to the steps [S503 to S505] in a sharing mode among the flowchart shown in FIG. 5.

Referring to FIG. 8A, it shows a state of executing a gallery application before entering a sharing mode. The gallery application may be non-limited by a specific application and may include an application used for reading image data. Referring to the diagram showing the state of executing the gallery application, a controller 180 can output a thumbnail list 801-1 for a plurality of image data via a display 151.

As mentioned in the foregoing description, if a prescribed gesture input inputted by a user is detected, as shown in FIG. 8B, the controller 180 can enter a sharing mode and may output a thumbnail list 801-2 on an auxiliary display area 151-2 [S503]. Yet, if the thumbnail list 801-2 is outputted on the auxiliary display area 151-2, the thumbnail list may be displayed by a line or two lines according to an area.

As mentioned in the foregoing description, the sharing mode may correspond to a mode that a user 401 of a mobile terminal 100 outputs a picture (or different data) and shows the picture to a counterpart 402. Since it is assumed that a main display area 151-1 is seen to the counterpart 402 in the sharing mode according to one embodiment of the present invention, outputted information and/or a control area can be provided to the user 401 via the auxiliary display area 151-2.

Moreover, the controller 180 can output one image data among the thumbnail list 801-2 on the main display area 151-1. According to an example shown in FIG. 8B, among a first thumbnail 801a, a second thumbnail 801b, . . . included in the thumbnail list 801-2, a first image data 803-1 corresponding to the first thumbnail 801a is outputted on the main display area 151-1.

And, in order to make the first thumbnail 801a corresponding to the first image data 803-1 to be identified in the thumbnail list 801-2, it may display a selection indicator 802.

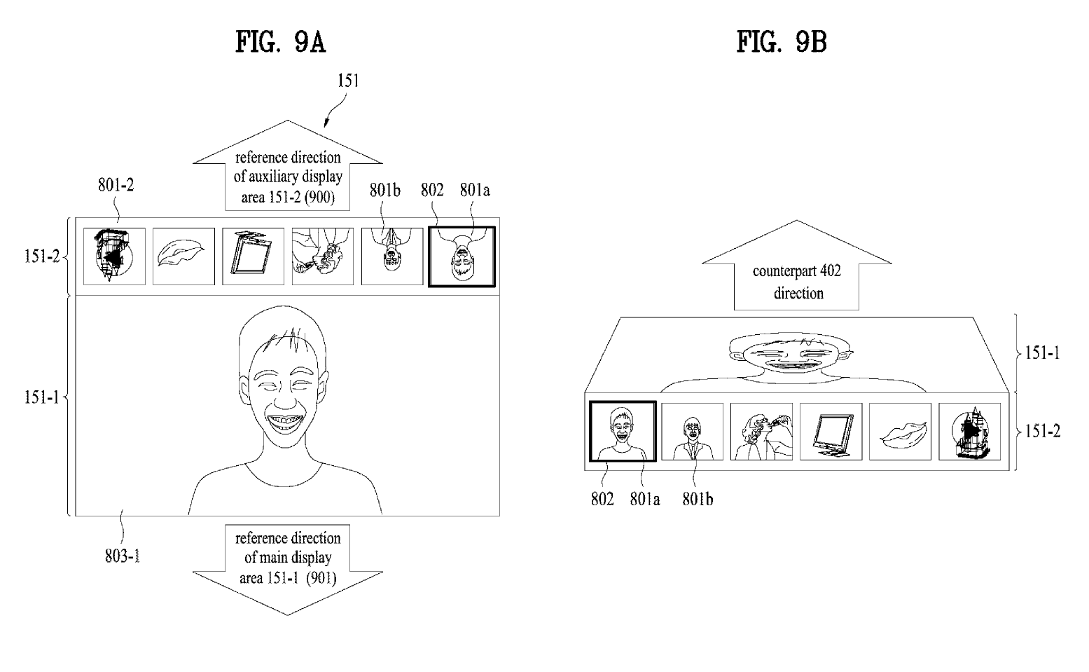

Meanwhile, as mentioned in the foregoing description, the auxiliary display area 151-2 may correspond to an area seen to the user 401. Hence, one embodiment of the present invention proposes data outputted on the auxiliary display area 151-2 to be outputted on the basis of a different direction. Regarding this embodiment, it shall be described in the following with reference to FIGS. 9A and 9B.

FIGS. 9A and 9B are diagrams for a control method of a criterion differently outputting a main display area 151-1 and an auxiliary area 151-2.

Referring to FIG. 9A, a thumbnail list 801-2 outputted on an auxiliary display area 151-2 is outputted upside down and FIG. 9B shows the auxiliary display area and a main display area 151-1 seen from a vision of a user 401.

As shown in FIG. 9A, an output reference direction of the auxiliary display area 151-2 corresponds to an up direction 900. As shown in FIG. 9B, the auxiliary display area 151-2 is correctly outputted on the basis of the vision of the user. Hence, the controller 180 can control an output reference direction of the main display area 151-1 and the output reference direction of the auxiliary display area to be different from each other.

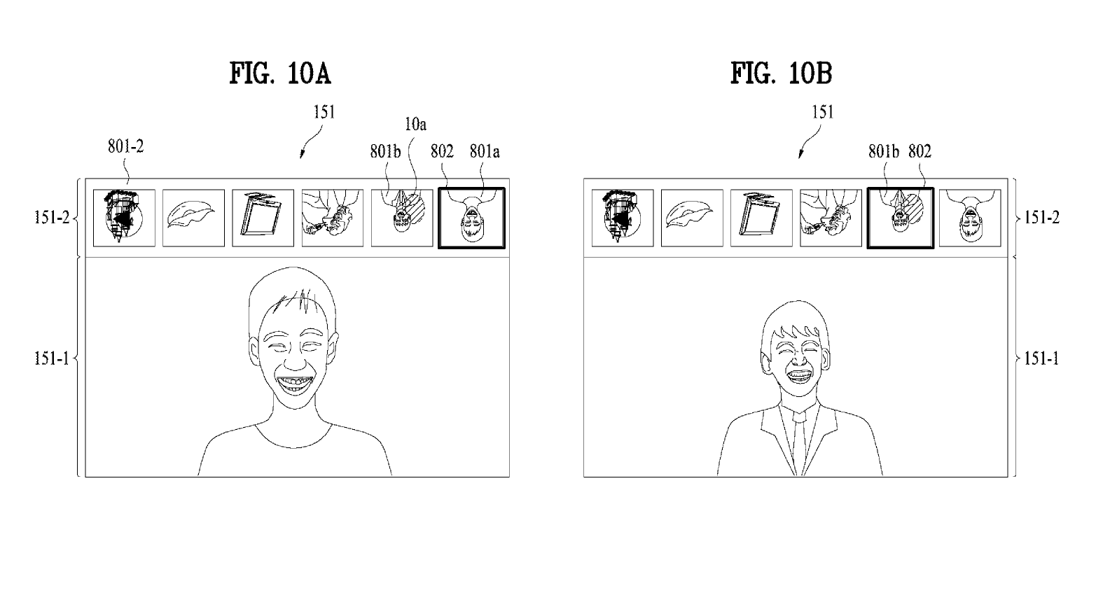

FIGS. 10A and 10B are diagrams for a control method controlling a main display area 151-1 using a thumbnail list according to one embodiment of the present invention.

Referring to FIG. 10A, it shows a state in a sharing mode. A thumbnail list 801-2 is outputted in an auxiliary display area 151-2. If an input 10a selecting an item from the thumbnail list 801-2 is received, the controller 180 outputs an image data corresponding to the selected item on the main display area 151-1.

Meanwhile, the selection input 10a may correspond to an input touching an item to select and dragging the item to the main display area 151-1, by which the present invention may be non-limited.

As shown in FIG. 10A, if an input 10a selecting a second thumbnail 801b is received, the controller 180 can output an image data corresponding to the second thumbnail 801b on the main display area 151-1 as shown in FIG. 10B. And, in order to make the second thumbnail 802b to be identified in the thumbnail list 801-2, the controller 180 can output a selection indicator 802 on the second thumbnail 810b.

In particular, in case of showing a picture to a counterpart 402, a user 401 may be able to control the picture to be selected and outputted using the auxiliary display area 151-2 only without reading data outputted on the main display area 151-1.

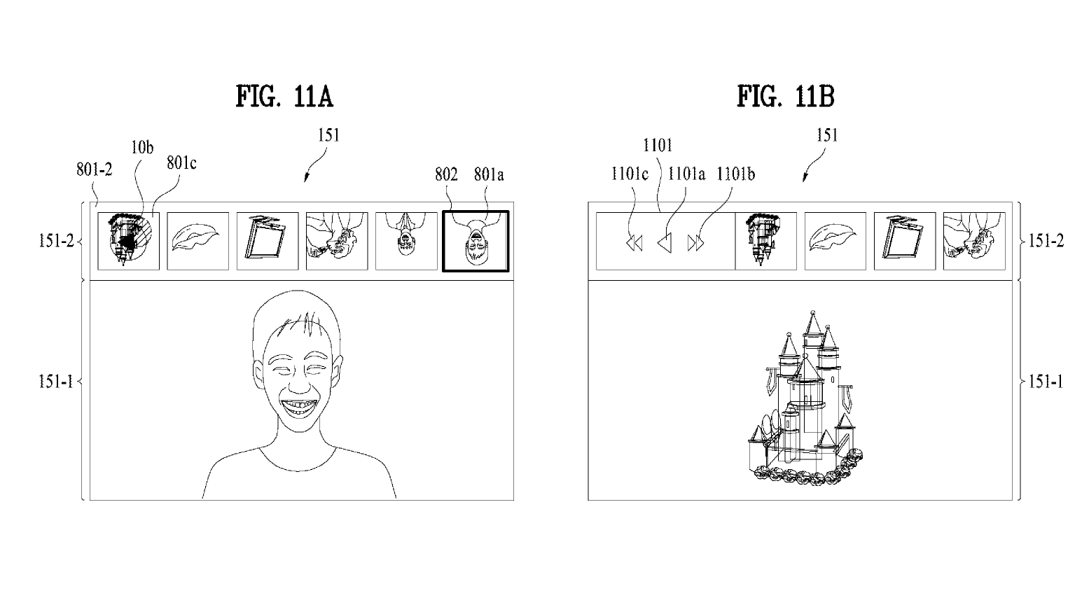

If an image data corresponds to a video data, one embodiment of the present invention proposes to additionally output a control area on an auxiliary area to play the video data. Regarding this embodiment, it shall be described in the following with reference to FIG. 11.

FIGS. 11A and 11B are diagrams for a control method outputting a control area configured to control playback of a video data on an auxiliary display area 151-2 according to one embodiment of the present invention.

Referring to FIG. 11A, a thumbnail list 801-2 is outputted on an auxiliary display area 151-2 and assume that a third thumbnail 801c among the thumbnail list 801-2 corresponds to a video data. If an input 10b selecting the third thumbnail is received, the controller 180 can further output a control area 1101 on the auxiliary display area 151-2 to control output of a video. The control area 1101 is outputted on the auxiliary display area 151-2 instead of the main display area 151-1 to make a user 402 more conveniently control playback of video data. This is because the auxiliary display area 151-2 corresponds to an output area provided to the user 402.

As shown in FIG. 11B, the control area 1101 can include a playback icon 1101a, a rewind icon 1101b and a fast-forward icon 1101c.

Meanwhile, if the input 10b selecting the third thumbnail is received, the controller 180 can play a video data corresponding to the third thumbnail via the main display area 151-1. The controller 180 may additionally control video data in response to a user input received via the control area 1101.

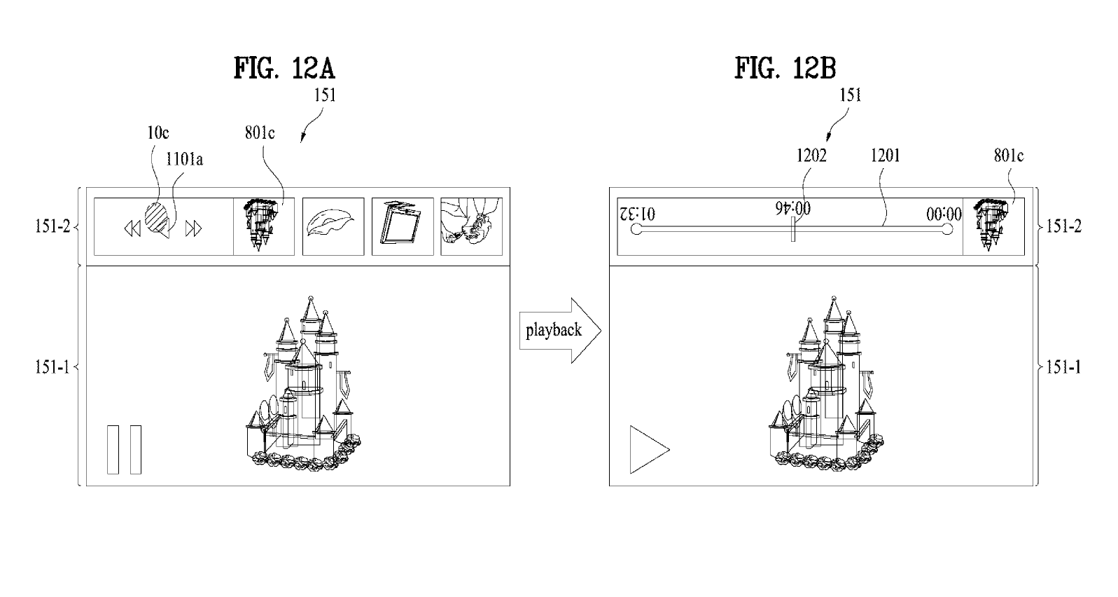

Meanwhile, it may be not easy to control playback of a video using the aforementioned control area 1101 only. Hence, one embodiment of the present invention proposes to output a playback progressive bar on the auxiliary display area 151-2 in case of playing a video data. Regarding this embodiment, it shall be described in the following with reference to FIG. 12.

FIGS. 12A and 12B are diagrams for a control method outputting a playback progressive bar on an auxiliary display area 151-2 while a video data is played according to one embodiment of the present invention.

Referring to FIG. 12A, it shows a state that a third thumbnail 801c corresponding to a video data is selected in a sharing mode. Referring to FIG. 12A, it shows a still frame of the video data corresponding to the third thumbnail 801c.

If a playback command is received via a control area 1101, the controller 180 outputs a video data on the main display area 151-1 and can output a playback progressive bar 1201 on the auxiliary display area 151-2 in response to the played video data. And, the controller may output the third thumbnail 801c on the auxiliary display area together with the playback progressive bar 1201.

If a position of a playback point indicator 1202 is moved to the left or right on the playback progressive bar 1201, the controller 180 may play a video by changing a playback point of the video. Since a control method using the playback progressive bar 1201 is identical to a general control method, detailed explanation is omitted at this time.

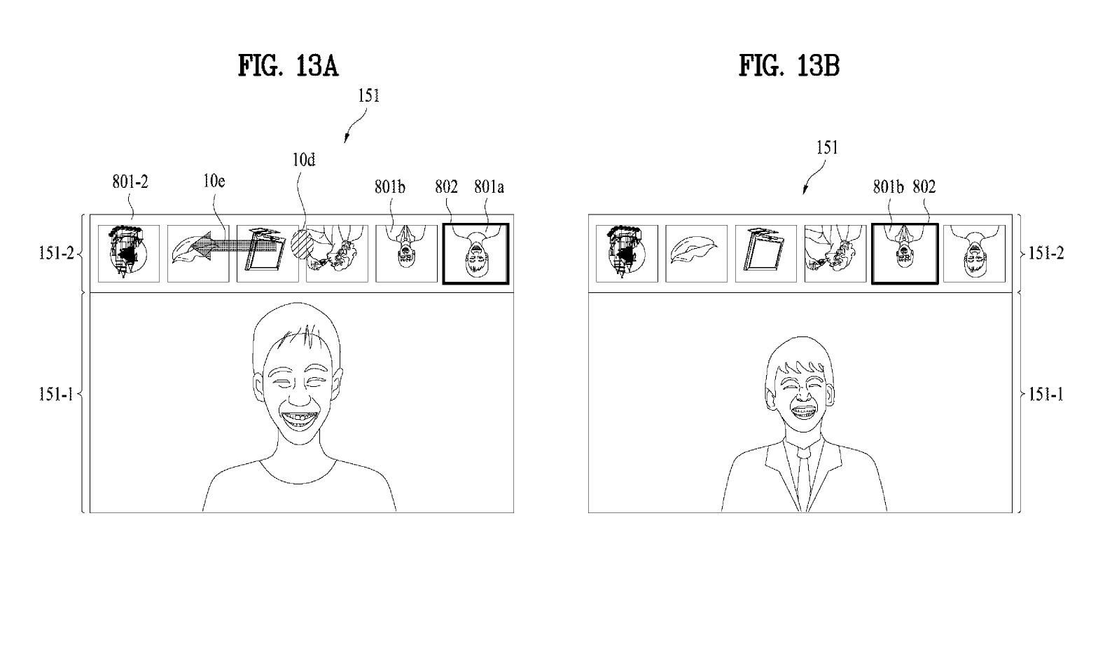

Meanwhile, one embodiment of the present invention proposes to control output of a main display area 151-1 using a gesture input of a user received via an auxiliary display area 151-2. Regarding this embodiment, it shall be described in the following with reference to FIG. 13.

FIGS. 13A and 13B are diagrams for a control method controlling an output of a main display area in response to a touch gesture input of a user received on an auxiliary display area according to one embodiment of the present invention.

Referring to FIG. 13A, it show a sharing mode. An image corresponding to a first thumbnail 801a is outputted on a main display area 151-1 and a thumbnail list 801-2 is outputted on an auxiliary display area 151-2.

If prescribed touch gestures 10d and 10e are received on the auxiliary display area 151-2, the controller 180 can control an output of the main display area 151-1. According to one embodiment of the present invention, it is able to control the main display area 151-1 to output a next image in response to an input touching 10d the auxiliary display area 151-2 and dragging 10e in a first direction. Moreover, according to one embodiment of the present invention, it is able to control the main display area 151-1 to output a previous image in response to an input touching 10d the auxiliary display area 151-2 and dragging in a second direction.

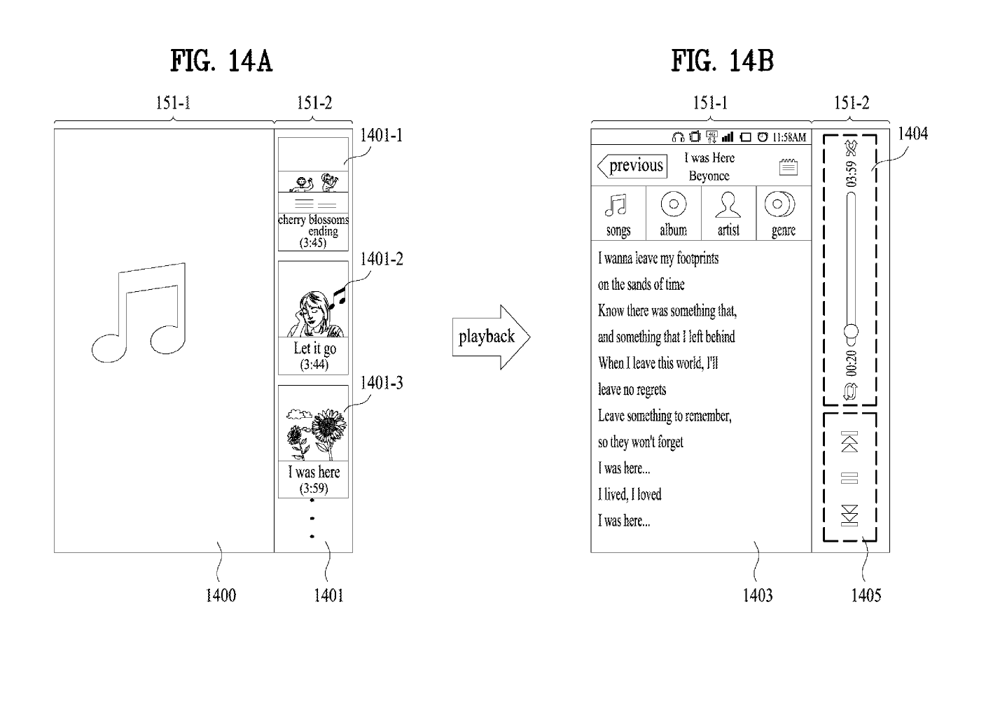

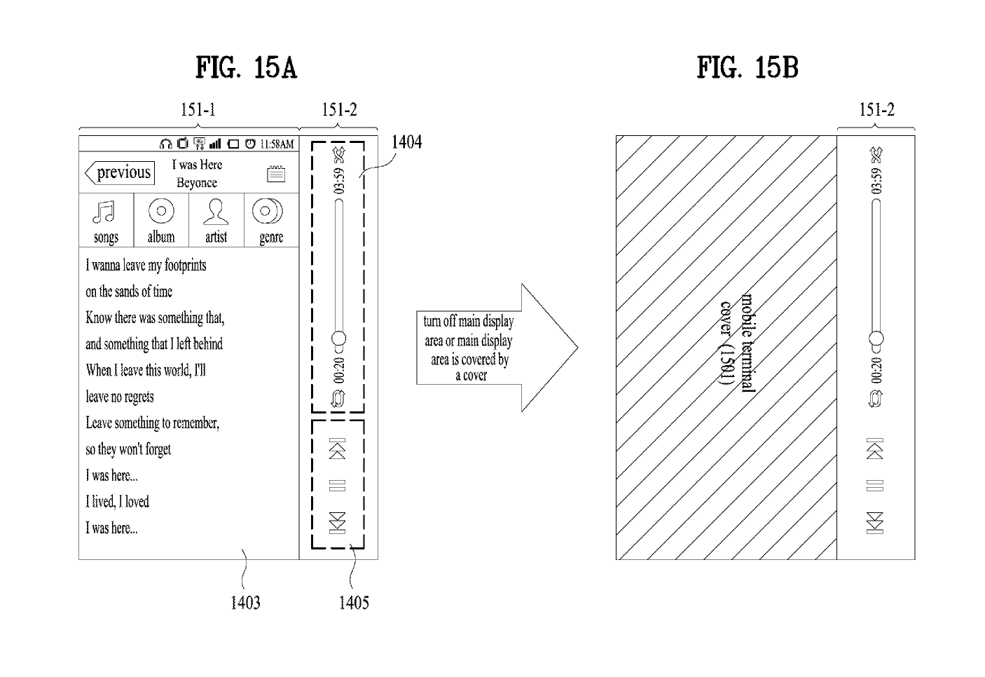

Meanwhile, a different embodiment of the present invention intends to provide a control method to provide convenience to a user using specificity of an auxiliary display area. In particular, the present invention proposes a control method in case of executing an application capable of playing music. In the following, the control method is explained with reference to FIG. 14 and FIG. 15.

FIGS. 14A and 14B are diagrams for a control method outputting a control area necessary for playing music via an auxiliary display area according to one embodiment of the present invention in case of executing a music playback application.

Referring to FIG. 14A, it shows an execution screen of a music playback application executed by a mobile terminal 100 via a main display area 151-1. The mobile terminal 100 outputs a music playback list 1401 on an auxiliary display area 151-2.

As shown in the music playback list of FIG. 14A, each item on the list can include at least one selected from the group consisting of ‘music title’, ‘playing time’ and ‘album image’. If an input selecting one item from the music playback list 1401 is received, the controller 180 can play music corresponding to the selected item.

FIG. 14B is a diagram for a state of a display unit 151 in case of playing music. One embodiment of the present invention proposes to use an auxiliary display area 151-2 to output a control area capable of controlling music playback in case of playing music.

Referring to FIG. 14B, ‘album image’ and/or ‘song lyrics’ is outputted on a main display area 151-1 and a control area 1405 and a playback progressive bar 1404 are outputted on an auxiliary display area 151-2. In particular, according to one embodiment of the present invention, when music is playing, control of music playback can be more conveniently performed via the control area 1405 and the playback progressive bar 1404 outputted on the auxiliary display area 151-2.

In particular, in case of playing music, amount of information outputted on the display may be relatively small. Hence, it may be more convenient to provide a control area using the auxiliary display area 151-2. This is because, if the main display area 151-1 is inactivated and the auxiliary display area 151-2 is activated only, music playback can be controlled while power loss is minimized. A strong point of the aforementioned control method is explained in more detail in the following with reference to FIG. 15.

FIGS. 15A and 15B are diagrams for explaining a merit of a control method controlling music playback in an auxiliary display area according to one embodiment of the present invention.

As mentioned earlier in FIGS. 14A, 14B, 15A and 15B shows a state that a control area is provided on an auxiliary display area 151-2. In this case, although a display is inactivated, music should be continuously played. Hence, according to a legacy control method, when music is played in a state that the display is inactivated, if a user intends to control the music playback, the user should activate the inactivated display.

On the contrary, according to the aforementioned one embodiment of the present invention, since the control area is able to be provided by activating the auxiliary display area 151-2 only, it is able to perform preferred control only without unnecessary power waste.

And, as shown in FIG. 15B, although a main display area 151-1 of a mobile terminal 100 is covered by a cover 1501, an auxiliary display area 151-2 installed in the side of the mobile terminal 100 may not be covered by the cover. Hence, although the main display area is covered by the cover, a user may be able to easily control music playback via the auxiliary display area 151-2.

Moreover, according to one embodiment of the present invention, the mobile terminal 100 can further detect that the mobile terminal is covered by the cover. If the mobile terminal detects that the mobile terminal is covered by the cover, the mobile terminal may control a control area 1405 and/or a playback progressive bar 1404 to be outputted on the auxiliary display area 151-2.

Advantages and effects of a mobile terminal according to the present invention and a method of controlling therefor are explained in the following.

According to at least one of embodiments of the present invention, it is able to provide UI appropriate for a mobile terminal to which a flexible display is applied.

It will be apparent to those skilled in the art that the present invention can be specified into other form(s) without departing from the spirit or scope of the inventions.

The above-described methods can be implemented in a program recorded medium as computer-readable codes. The computer-readable media include all kinds of recording devices in which data readable by a computer system are stored. The computer-readable media include ROM, RAM, CD-ROM, magnetic tapes, floppy discs, optical data storage devices, and the like for example and also include carrier-wave type implementations (e.g., transmission via Internet). And, the computer can include the control unit 180 of the terminal.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A mobile terminal, comprising:
a display comprising a main display area located on a first side of the mobile terminal and an auxiliary display area located on a second side of the mobile terminal; and
a controller configured to:
switch to an image sharing mode when a preset condition is satisfied; and
cause the display to display image data on the main display area and display a thumbnail list including a plurality of images on the auxiliary display area in the image sharing mode, the image data corresponding to at least one of the plurality of images.

2. The mobile terminal of claim 1, wherein the display further comprises a flexible display that is deformable such that the main display area and the auxiliary display area are formed in response to bending of at least one portion of the flexible display.

3. The mobile terminal of claim 1, wherein each of the main display area and the auxiliary display is angled differently such that the thumbnail list and the image data are displayed toward different directions.

4. The mobile terminal of claim 3, wherein:
the mobile terminal further comprises a sensor configured to detect movement of the mobile terminal; and
the preset condition is satisfied when the mobile terminal is moved such that the main display area faces a horizontal direction.

5. The mobile terminal of claim 1, wherein:
the mobile terminal further comprises a sensor configured to detect movement of the mobile terminal; and
the preset condition is satisfied when the mobile terminal is rotated more than a threshold angle.

6. The mobile terminal of claim 1, wherein the preset condition is satisfied when a touch input is applied to the auxiliary display area.

7. The mobile terminal of claim 6, wherein:
the auxiliary display area comprises a first auxiliary display area located at a first lateral side of the mobile terminal and a second auxiliary display area located at a second lateral side of the mobile terminal;
the main display area is located between the first auxiliary display area and the second auxiliary display area; and
the preset condition is satisfied when at least one first touch input is applied on the first auxiliary display area and at least two second touch inputs are applied on the second auxiliary display area.

8. The mobile terminal of claim 1, wherein the controller is further configured to cause displaying of a first image on the main display area in response to an input for selecting the first image from the thumbnail list, the input received via the auxiliary display area in the sharing mode.

9. The mobile terminal of claim 1, wherein:
the controller is further configured to cause displaying of a control area on the auxiliary display area when the image data displayed on the main display area is video data; and
the control area is for receiving a touch input for controlling playback of the video data.

10. The mobile terminal of claim 9, wherein the controller is further configured to:
cause displaying of the video data played back on the main display area in response to a playback command applied via the control area; and
cause displaying of a playback progressive bar on the auxiliary display area while the played back video data is displayed on the main display area.

11. A method for controlling a mobile terminal, wherein the mobile terminal comprises a display comprising a main display area located on a first side of the mobile terminal and an auxiliary display area located on a second side of the mobile terminal, the method comprising:
switching to an image sharing mode when a preset condition is satisfied; and
displaying image data on the main display area and a thumbnail list including a plurality of images on the auxiliary display area in the image sharing mode, the image data corresponding to at least one of the plurality of images.

12. The method of claim 11, wherein the display further comprises a flexible display that is deformable such that the main display area and the auxiliary display area are formed in response to bending of at least one portion of the flexible display.

13. The method of claim 11, wherein each of the main display area and the auxiliary display is angled differently such that the thumbnail list and the image data are displayed toward different directions.

14. The method of claim 13, further comprising detect movement of the mobile terminal, wherein the preset condition is satisfied when the mobile terminal is moved such that the main display area faces a horizontal direction.

15. The method of claim 11, wherein:
the mobile terminal further comprises a sensor configured to detect movement of the mobile terminal; and
the preset condition is satisfied when the mobile terminal is rotated more than a threshold angle.

16. The method of claim 11, wherein the preset condition is satisfied when a touch input is applied to the auxiliary display area.

17. The method of claim 16, wherein:
the auxiliary display area comprises a first auxiliary display area located at a first lateral side of the mobile terminal and a second auxiliary display area located at a second lateral side of the mobile terminal;
the main display area is located between the first auxiliary display area and the second auxiliary display area; and
the preset condition is satisfied when at least one first touch input is applied on the first auxiliary display area and at least two second touch inputs are applied on the second auxiliary display area.

18. The method of claim 11, further comprising:
displaying a first image on the main display area in response to an input for selecting the first image from the thumbnail list, the input received via the auxiliary display area in the sharing mode.

19. The method of claim 11, further comprising:
displaying a control area on the auxiliary display area when the image data displayed on the main display area is video data,
wherein the control area is for receiving a touch input for controlling playback of the video data.

20. The method of claim 19, further comprising:
displaying the video data played back on the main display area in response to a playback command applied via the control area; and
displaying a playback progressive bar on the auxiliary display area while the played back video data is displayed on the main display area.
